(19) United States
(12) Patent Application Publication
(10) Pub. No.: US 2019/0083986 A1
(43) Pub. Date: Mar. 21, 2019

(54) KNIFE FOR A COMMINUTING MACHINE

(71) Applicant: UNTHA shredding technology GmbH, Kuchl (AT)

(72) Inventors: Stefan PISCHON, Kuchl (AT); Josef KAINDL, Golling (AT)

(21) Appl. No.: 16/196,655

(22) Filed: Nov. 20, 2018

Related U.S. Application Data
(63) Continuation of application No. PCT/AT2017/060090, filed on Apr. 10, 2017.

(30) Foreign Application Priority Data
May 27, 2016 (EP) 16171760.8

(51) Int. Cl. B02C 18/18; B02C 18/14

(52) U.S. Cl. CPC B02C 18/18; B02C 18/145

(57) ABSTRACT

A blade for a comminuting machine includes two parallel base surfaces and at least three lateral surfaces. A base surface where two lateral surfaces meet is a cutting device (formed as a cutting edge), and a chip space is adjacent thereto. The chip space is inclined with respect to the base surface such that material comminuted by the cutting device is conveyed toward one of the lateral surfaces. The chip space extends between the two meeting lateral surfaces and has a first material outlet edge at one of the two meeting lateral surfaces and a second material outlet edge at the other of the two meeting lateral surfaces. The first material outlet edge is recessed more than the second material outlet edge so that most of the material comminuted by the cutting device leaves the blade at the first material outlet edge via the inclination of the chip space.

### BACKGROUND OF THE INVENTION

The invention concerns a blade for a comminuting machine for comminuting material, comprising two mutually parallel base surfaces and at least three lateral surfaces, wherein provided at at least one base surface in the region where two lateral surfaces meet is a cutting device and a chip space adjacent thereto. The invention further concerns a comminuting machine for comminuting material, in particular recyclable materials, waste wood and data carriers, including a machine frame, at least one comminuting rotor mounted rotatably to the machine frame and a material feed space, by way of which the material to be comminuted can be fed to the at least one comminuting rotor, wherein a plurality of blades according to the invention are arranged on the comminuting rotor.

FIG. 1 shows a relevant portion of a comminuting apparatus 3 for comminuting material, in particular recyclable materials, waste wood and data carriers. The comminuting machine 3 includes a machine frame 28 to which a comminuting rotor 29 is rotatably mounted.

The material to be comminuted by the comminuting rotor 29 is fed to the comminuting machine 3 by way of a material delivery space 30, wherein the delivery material space 30 can be loaded manually for example by wheel loaders, fork lift trucks or conveyor belts. The comminuting machine 3 further includes a feed device 35 which is mounted pivotably to the machine frame 28 and with which the material to be comminuted can be conveyed to the comminuting rotor 29.

The comminuting machine 3 in the embodiment shown in FIG. 1 includes a maintenance flap 36 which is pivotable into the material delivery space 30 thereby a maintenance operator 37 has access to the comminuting rotor 29.

Arranged on the comminuting rotor 29 for comminuting the material are blades with which the present invention is mainly concerned. Those blades cooperate with stationary fixed counterpart blades 38 which can be in the form of stator blades or stripping combs. Preferably the counterpart blades 38 are fixedly connected to the machine frame 28. To bring about a relative movement between the blades arranged on the comminuting rotor 29 and the counterpart blades 38 the comminuting rotor 29 performs a rotational movement in a given direction of rotation 33 about the axis of rotation 34. The circle defined by the tips of the blades during that rotary movement is denoted by reference 32.

The material comminuted between the rotating blades and the stationary counterpart blades is subsequently discharged through a sieve device 31 which determines the comminuting factor in accordance with the sieve size, and further conveyed for example by means of a conveyor belt, a conveyor screw, a chain conveyor or a suction removal installation.

FIGS. 2a-2d show a blade 101 according to the state of the art, as described for example in EP 2 848 311 A1. In that respect, FIG. 2a shows a perspective view, FIG. 2b shows a side view of the lateral surfaces 109 and 108, FIG. 2c shows a plan view on to the base surface 104 and FIG. 2d shows a plan view on to the opposite base surface 105. In detail the blade 101 is of a substantially cuboidal configuration and includes two base surfaces 104 and 105 and four lateral surfaces 106, 107, 108, 109. Provided at the base surface 104 in the region where the two lateral surfaces 108 and 109 meet is a cutting device 110 and a chip space 111 adjacent thereto. The blade 101 is of a corresponding configuration at the second opposite base surface 105.

In this arrangement the cutting devices 110 are in the form of a cutting tip. The material comminuted by the blade 101 or a cutting tip 110 passes into the chip space 111 provided adjacent thereto. That chip space 111 respectively extends between two lateral surfaces 106, 107, 108 and 109 respectively, and forms a respective material outlet edge 119 and 120 at each of the lateral surfaces in question. Those material outlet edges 119 and 120 are identical. The bottom of the chip space 111 is disposed in a plane oriented parallel to the base surfaces 104 and 105.

FIG. 3 diagrammatically shows a comminuting rotor 29 with a blade 101 arranged thereon in comminuting operation. Also diagrammatically shown is the sieve device 31 which region-wise surrounds the comminuting rotor 29.

The blade 101 according to the state of the art suffers from a series of disadvantages: by virtue of the fact that the cutting device 110 is in the form of a cutting tip the cutting device 110, particularly when comminuting contaminated material, that is to say material which has impurities, has a severe tendency to suffer from wear phenomena or to break off or away. In addition when processing or comminuting solid materials (lumps, chunks, sprue gates and so forth) no real cutting action is involved. Rather, tearing takes place whereby the blade 101 is essentially suitable only for comminuting films. If FIG. 3 is viewed it becomes clear that there is only point contact with the perforated sieve 31 in the region of the perforated sieve 31 upon rotation of the blade 101 about the axis of rotation 34 of the comminuting rotor 29. That also results in a reduced comminuting effect.

A further disadvantage is also the fact that the material discharged from the cutting tip 110 passes into the chip space 111 and accumulates by virtue of the configuration of the chip space 111 at the blade 101, whereby this can result in material aggregation and in the worst-case scenario blocking of the comminuting rotor 29.

DE 10 2007 043 687 shows a tool for a comminuting apparatus, wherein an item can be comminuted by a first, second and third cutting edge. In that case a cutting edge passes simultaneously along its entire length into the item and comminutes it. After separation of a part of the item to the comminuted that separated part is guided away downwardly by way of working surfaces of a concave configuration.

US 2010 054 498 represents a general state of the art.

### SUMMARY OF THE INVENTION

The object of the invention is therefore to provide a blade which is improved in relation to the state of the art for a comminuting machine for comminuting material and a comminuting machine having such an improved blade, wherein the blade is distinguished in particular by increased insensitivity to trouble and an optimum cutting action even in relation to solid materials and in particular also in the region of the sieve device.

It is therefore provided according to the invention that the cutting device is in the form of a cutting edge and the chip space is inclined with respect to the at least one base surface in such a way that material comminuted by the cutting device can preferably be conveyed in the direction of one of the lateral surfaces. The chip space extends, preferably exclusively, between the two meeting lateral surfaces and has a first material outlet edge at one of the two meeting lateral surfaces and a second material outlet edge at the other of the two meeting lateral surfaces, wherein the first material outlet edge is recessed more greatly than the second material outlet edge—with respect to the at least one base surface—so that the greatest part of the material comminuted by the cutting device leaves the blade at the first material outlet edge by virtue of the inclination of the chip space.

The wear phenomena are markedly reduced by virtue of the fact that the cutting device is in the form of a cutting edge and not in the form of a cutting tip as in the state of the art. In addition the cutting device provides an actual cutting action and not a mere tearing effect in relation to the material to be comminuted. In the case of the provision of a sieve device in a comminuting machine the cutting edges of the blades substantially form a line contact and not a point contact, whereby the comminuting action is also enhanced. Viewed overall the cutting action and thus the chip flow is enhanced and at the same time susceptibility to trouble is reduced by the fact that the cutting device is in the form of a cutting edge.

At the same time, because the chip space is inclined in relation to the at least one base surface in such a way that material comminuted by the cutting device can preferably be conveyed in the direction of one of the lateral surfaces, this ensures that the material which is discharged in a particularly efficient fashion in comparison with the state of the art is also particularly efficiently conveyed away from the cutting device and the blade, insofar as it is not lined up in normal relationship at the chip surface of the chip space, but is conveyed away in a preferential direction, namely in the direction of one of the lateral surfaces.

Advantageous embodiments of the invention are described below and can significantly increase the service life of the blade. If the cutting device and the chip space provided adjacent thereto are worn in a region where two lateral surfaces meet then the blade only has to be turned and/or rotated and can come into use like a fresh blade. That process can be repeated so frequently until all cutting device on the blade and chip spaces adjacent thereto are worn out.

The blade can be substantially identical at the two base surfaces, wherein the cutting edge and the chip space or the cutting edges and the chip spaces of the second base surfaces are arranged in laterally reversed relationship with the cutting edge and the chip space or the cutting edges and the chip spaces of the first base surface, it is possible to select whether the chip flow is directed towards the left or the right, by suitable fitment of the blade to the comminuting rotor. In particular configurations are also possible in which for example the material is conveyed towards the left in the left-hand region of the comminuting rotor and towards the right in the right-hand region of the comminuting rotor, thereby overall ensuring that the cut or comminuted material is transported away from the comminuting rotor in particularly efficient fashion.

### BRIEF DESCRIPTION OF THE DRAWINGS

Further details and advantages of the invention are described in greater detail hereinafter by the specific description with reference to the drawings, in which:

FIG. 1 shows a portion of a comminuting machine,

FIGS. 2a-2d show a blade according to the state of the art as a perspective view (FIG. 2a), a side view (FIG. 2b) and two plan views (FIGS. 2c and 2d),

FIG. 3 shows the blade according to the state of the art in comminuting operation,

FIGS. 4a-4d show a blade according to the invention in a first preferred embodiment as a perspective view (FIG. 4a), a side view (FIG. 4b) and two plan views (FIGS. 4c and 4d),

FIG. 5 shows the blade according to the first preferred embodiment in comminuting operation,

FIGS. 6a and 6b show a portion of a comminuting rotor with blades arranged thereon in accordance with the first preferred embodiment from two different viewing directions,

FIGS. 6c and 6d show details of the device for holding the blades according to the first preferred embodiment on the comminuting rotor, and

FIGS. 7a and 7b show a blade of the invention according to a second preferred embodiment as a perspective view (FIG. 7a) and a plan view (FIG. 7b).

### DETAILED DESCRIPTION OF THE INVENTION

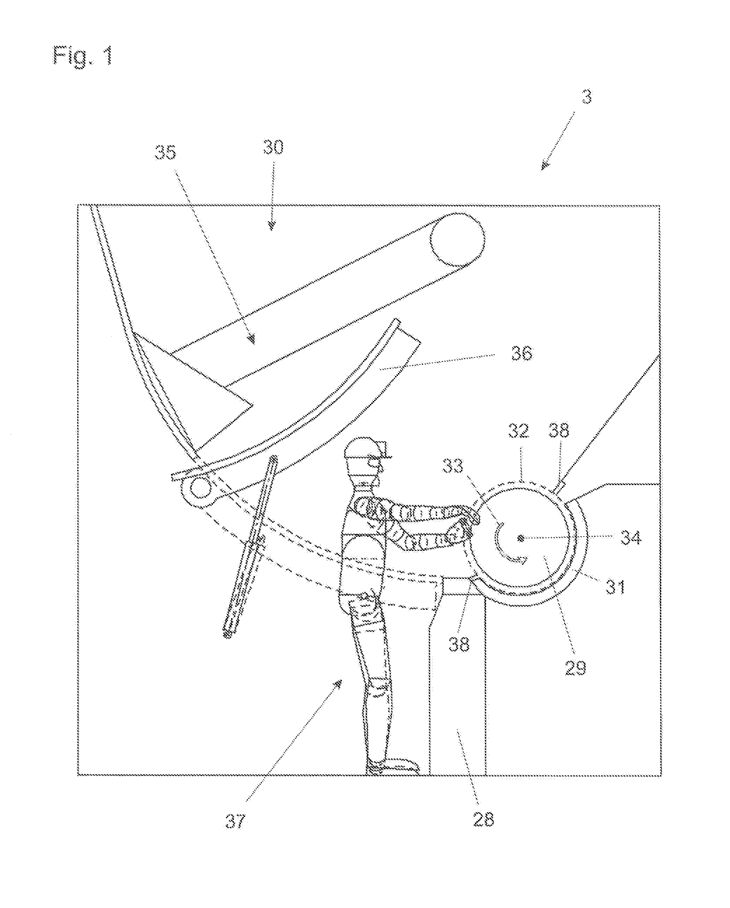

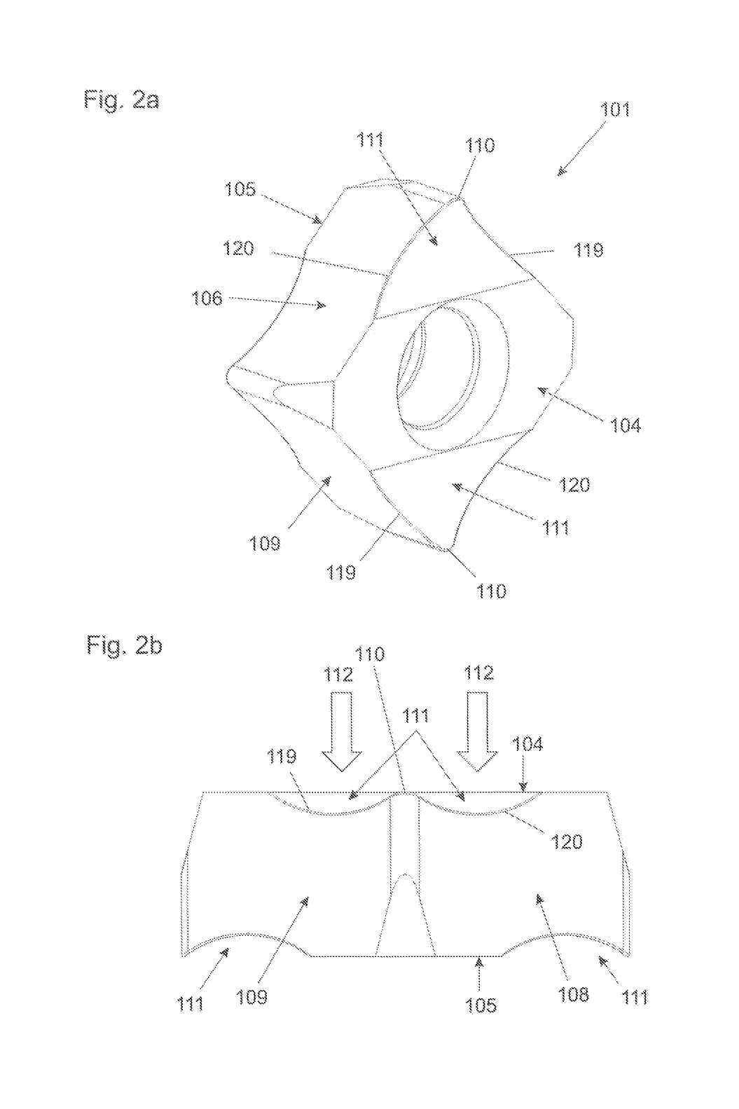

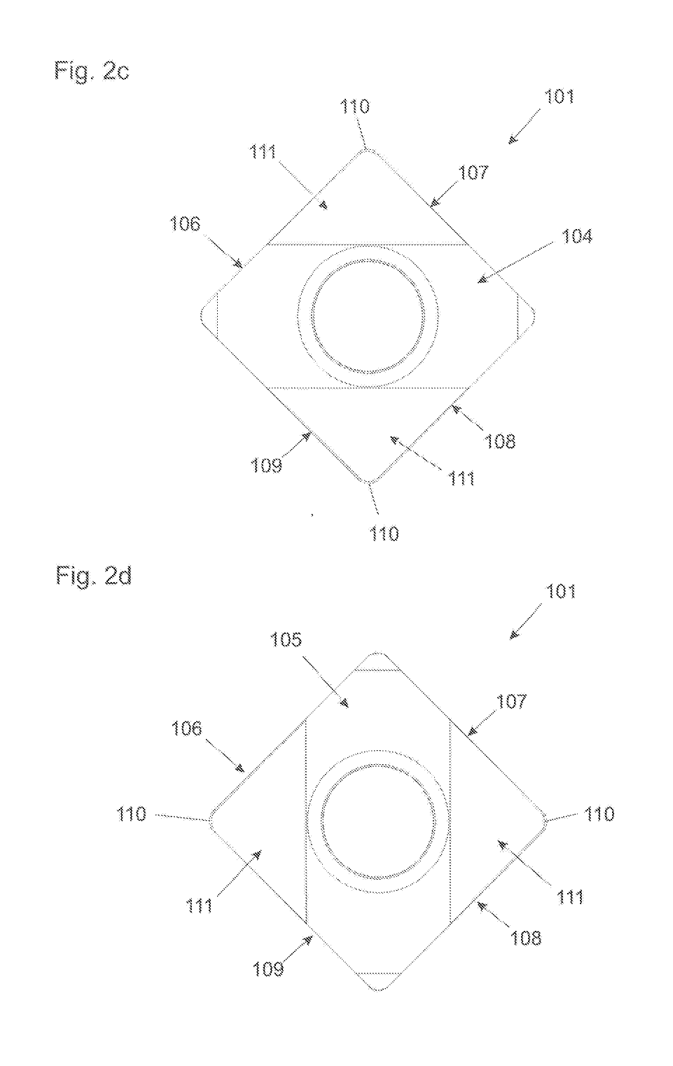

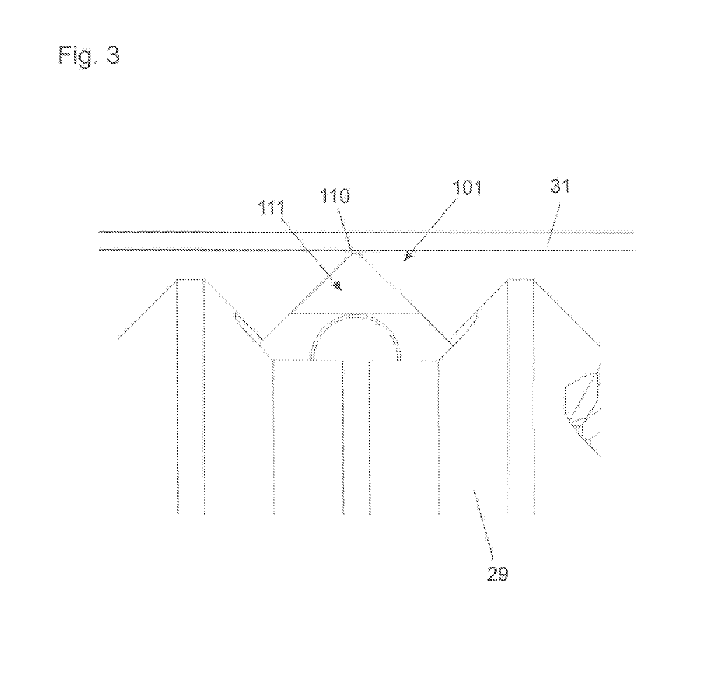

The embodiments described hereinafter of a blade according to the invention can be used, for example, in the comminuting machine shown in FIG. 1.

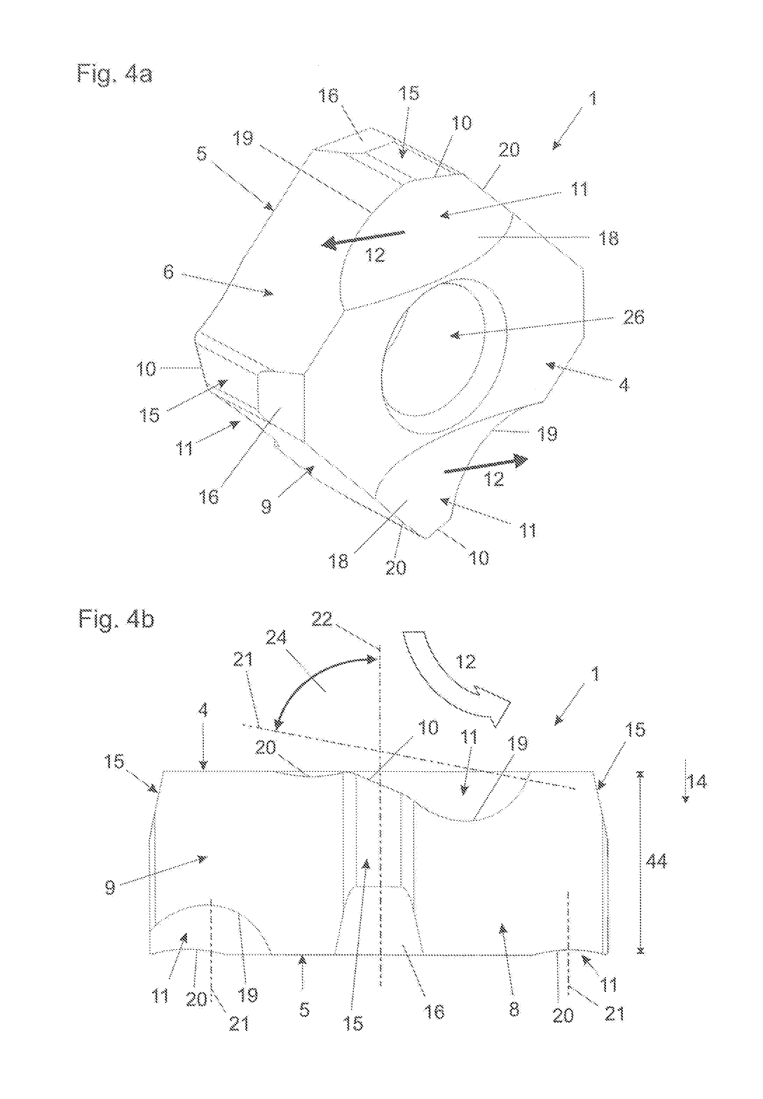

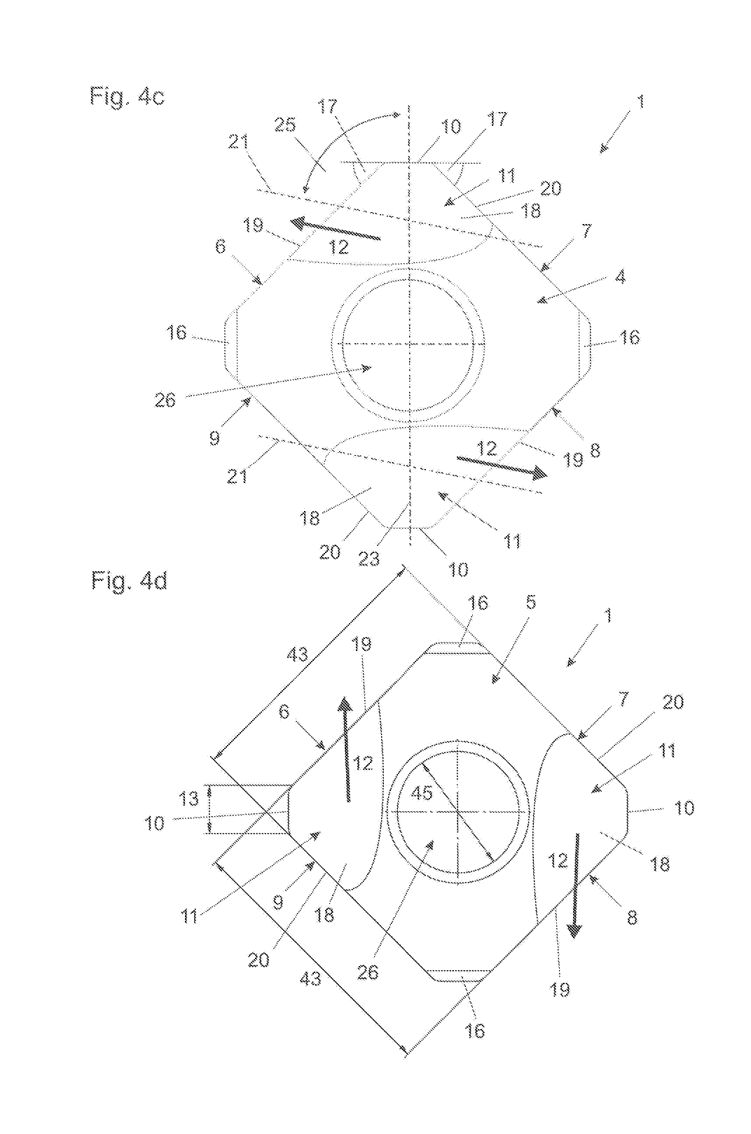

FIGS. 4a to 4d show a first preferred embodiment of a blade 1 according to the invention for a comminuting machine for comminuting material.

The blade 1 has two base surfaces 4 and 5 spaced from each other. The spacing 44 can be for example 20 mm. In the illustrated case the base surfaces 4 and 5 are of a substantially quadrangular, more precisely square, configuration, with an edge length 43 of for example 40 mm. Other embodiments with for example triangular base surfaces are however also conceivable.

The blade 1 further has four lateral surfaces 6, 7, 8 and 9 which connect the two base surfaces 4 and 5 together. A respective cutting device 10 and a chip space 11 provided adjacent thereto are arranged at the base surface 4 in the region where the lateral surfaces 6 and 7 meet and in the region where the lateral surfaces 8 and 9 meet. Correspondingly, a respective cutting device 10 and a chip space 11 provided adjacent thereto are disposed at the opposite base surface 5 in the region where the lateral surfaces 7 and 8 and 9 and 6 respectively meet. This means that the blade 1 is therefore substantially identical at the two base surfaces 4 and 5—as regards the relative arrangement of the cutting devices 10 and the chip spaces 11. It will be noted however that the cutting edges 10 and chip spaces 11 of the second base surface 5 are arranged turned through 90° relative to the cutting edges 10 and the chip spaces 11 of the first base surface 4.

A further difference is that the cutting edges 10 and the chip spaces 11 of the second base surface are arranged in laterally reversed relationship with respect to the cutting edges 10 and the chip spaces 11 of the first base surface 4, as can be seen from a direct comparison between FIGS. 4c and 4d.

The cutting devices 10 are each in the form of a cutting edge, the cutting edge 10 being of a width of 5-9 mm, preferably 7 mm.

The cutting edges 10 are each respectively provided at corner surfaces 15 disposed between the two lateral surfaces 6, 7, 8 and 9 respectively which meet, wherein the corner surfaces 15 in the region opposite the cutting edge 10 and adjoining the other base surface 4 and 5 respectively have a flattened portion 16 to avoid contact with the material to be comminuted. As can be seen from FIG. 4c the corner surfaces 15 substantially include an angle 17 of 45° relative to the two meeting lateral surfaces 6, 7, 8 and 9.

The fact that the blade 1 has in total four cutting devices 10 arranged at a base surface 4 and 5 respectively in the region where two lateral surfaces 6, 7, 8 and 9 meet and chip spaces 11 provided adjacent thereto means that the blade 4 can be used quadruple times. For example the blade 1 could be used in the following sequence: firstly the cutting edge 10 arranged between the lateral surfaces 6 and 7 is used. Then the blade 1 is turned through 180° about a central axis 22 oriented substantially normal to the lateral surfaces 4 and 5 so that the cutting edge 10 arranged between the lateral surfaces 8 and 9 is used. The blade 1 is then turned through 180° about a central axis 23 oriented substantially parallel to the two base surfaces 4 and 5 and at the same time a rotation through 90° about the central axis 22 is effected. Then—depending on the respective direction of rotation about the central axis 22—the cutting edge 10 arranged between the lateral surfaces 9 and 6 or the cutting edge 10 arranged between the lateral surfaces 7 and 8 would be used. Then the respective other cutting edge 10 is used in the fourth use. In that respect the flattened portions 16 serve to ensure that the blade 1 is worn away only in the region of the respective active cutting edge 10 and not in the region of the adjacent corner surfaces 15.

The fact that the cutting device 10 is in the form of a cutting edge of a given width 13 and is not in the form of a cutting tip as in the state of the art increases the service life of the cutting device 10 as a cutting edge 10 breaks away less easily than a cutting tip of a point shape. In addition the comminuting effect is enhanced as the blade 1 contacts the material to be comminuted over a larger region which is defined substantially by the width 13 of the cutting edge 10. The fact that the cutting device 10 is in the form of a cutting edge therefore has two substantial advantages over the state of the art: on the one hand the service life of the cutting device 10 is increased and on the other hand the cutting action is improved.

The chip spaces 11 arranged adjacent to the cutting devices 10 are inclined relative to the base surfaces 4 and 5 in such a way that material comminuted by the cutting devices 10 can preferably be conveyed in the direction 12 of one of the lateral surfaces 6, 7, 8 and 9. In the case of the chip space 11 which is disposed between the lateral surfaces 6 and 7 the material comminuted by the cutting device 10 is preferably conveyed in the direction 12 of the lateral surface 6. In the case of the chip space 11 between the lateral surfaces 8 and 9 the comminuted material is preferably conveyed in the direction 12 of the lateral surface 8.

As can be seen in particular from FIG. 4b the cutting edge 10 is inclined in the same direction 14 as the chip space 11. The chip space 11 is also in the form of a passage which widens in the preferred material conveying direction 12. In addition the chip space 11 is concave, therefore being curved inwardly in relation to the respective base surface 4 and 5 respectively. The chip face 18 which is in contact with the material comminuted by the cutting device 10 can be in that case of a cylindrical, conical or spherical configuration, that is to say it can represent part of a cylinder, a cone or a spherical surface. And finally it can be established that the chip space 11 is at least region-wise of an arcuate configuration in cross-section. All those measures improve the flow of material in the preferred material conveying direction 12.

As already stated the chip spaces 11 respectively extend between two meeting lateral surfaces 6, 7, 8 and 9. In that case the chip spaces 11 define a first material outlet edge 19 at one of the two meeting lateral surfaces 6, 7, 8 and 9 and a second material outlet edge 20 at the other of the two meeting lateral surfaces 6, 7, 8 and 9. In that case the first material outlet edge 19 is recessed more greatly in relation to the second material outlet edge 20—with respect to the at least one base surface 4 and 5 respectively. The material comminuted by the cutting device 10 can leave the blade by way of the material outlet edges 19 and 20 at the lateral surfaces 6, 7, 8 and 9, wherein in that respect the greatest part of the comminuted material leaves the blade at the first material outlet edge 19 by virtue of the inclination of the chip space 11. The two material outlet edges 19 and 20 are at least region-wise of an arcuate configuration. In addition the first material outlet edge 19 is of a greater curvature than the second material outlet edge 20, as can be seen for example from FIG. 4b.

The theoretical axis 21 of the concave chip spaces 11 which substantially corresponds to the central axis includes an acute angle 24 on the one hand in relation to the central axis 22 and an acute angle 25 on the other hand in relation to the central axis 23 of the blade 1.

The blade 1 has a central through opening 26 for connecting the blade 1 to a blade holder 27 (see also the following Figures). The through opening 26 can be provided in that case with a thread which is either cut directly into the blade 1 or is arranged on a threaded sleeve which is fitted into the blade 1. The diameter 45 of the through opening 26 is for example 18 mm.

The two base surfaces 4 and 5 are region-wise in the form of a support surface for supporting the blade 1 at a blade holder 27. This means that the blade 1 is supported at the blade holder 27 by way of that support surface in the condition of being mounted to the blade holder 27.

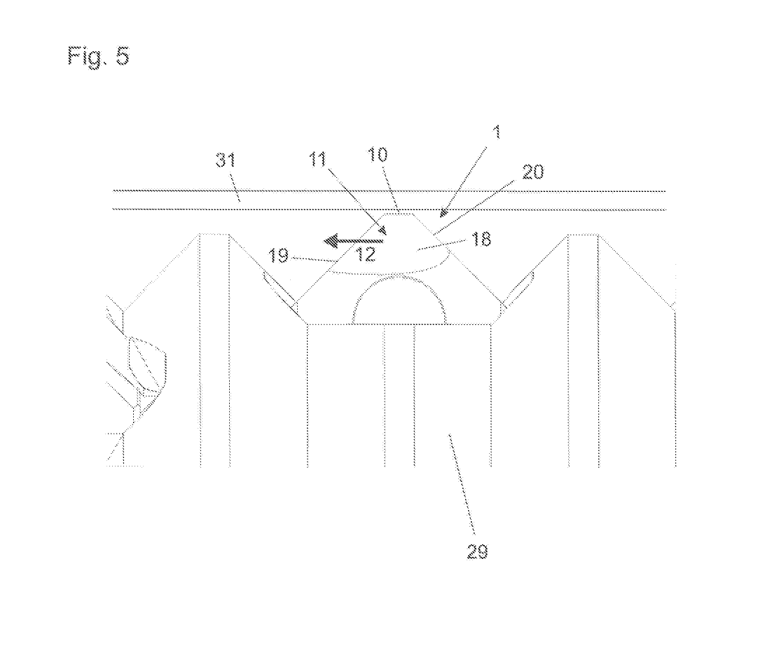

FIG. 5 shows a portion of a comminuting rotor 29 with a blade 1 arranged thereon, wherein the blade 1 is oriented relative to the comminuting rotor 29 in such a way that one of the cutting edges 10 on the blade 1 projects from the comminuting rotor 29 and comes into contact with the material to be comminuted upon rotation of the comminuting rotor 29. FIG. 5 also diagrammatically shows a part of the sieve device 31. This view makes it clear that the cutting edge 10 of the blade 1 substantially constitutes line contact with respect to the sieve device 31 whereby the cutting action is substantially increased. In the illustrated case the comminuted material is preferably conveyed away from the blade 1 in the direction 12 towards the left.

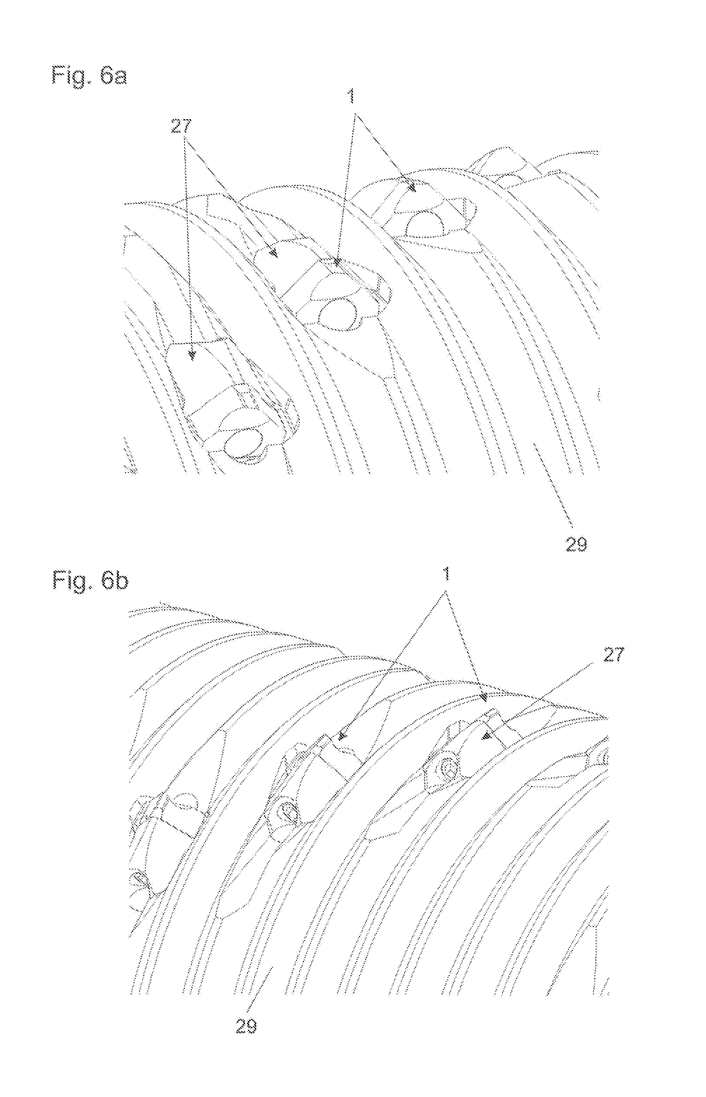

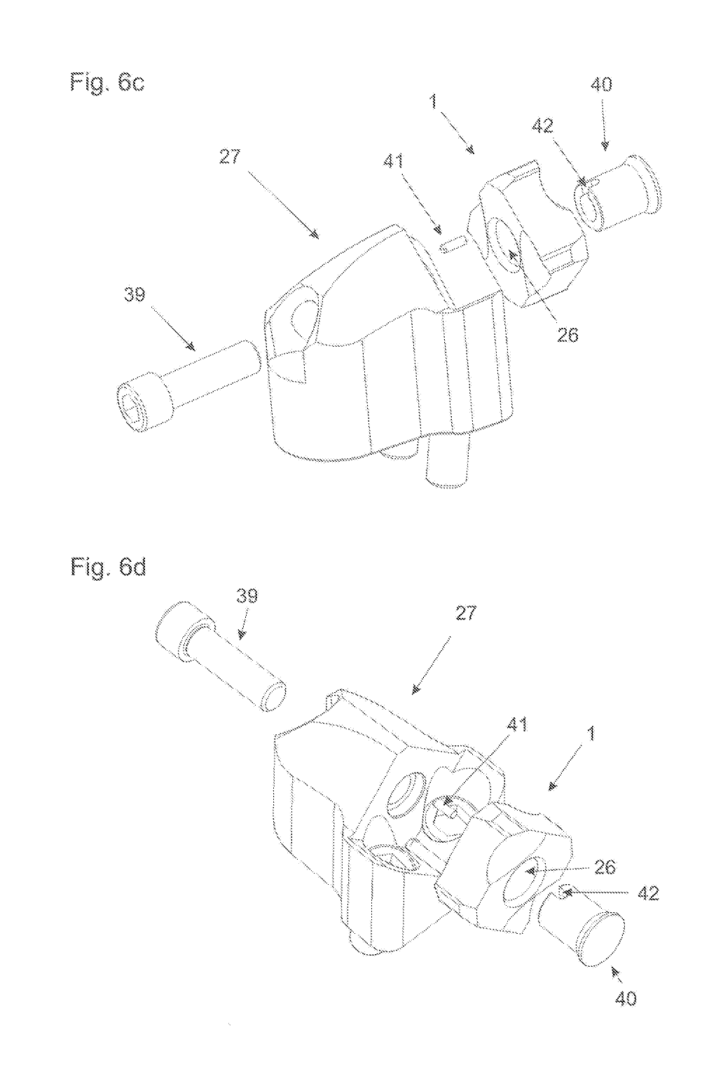

For mounting the blade 1 to the comminuting rotor 29 (see FIGS. 6a-6d) the blade 1 is fixed by means of a screw 39 engaging into a screw-in sleeve 40. To provide an anti-rotation securing action the arrangement has a bolt 41 which is held in positively locking relationship on the one hand on the blade holder 27 and on the other hand on the screw-in sleeve 40. A substantially U-shaped recess 42 is provided for holding the bolt 41 in the screw-in sleeve 40 in positively locking relationship.

As can be seen from FIGS. 6a and 6b the blades 1 are arranged in a spiral form on the comminuting rotor 29.

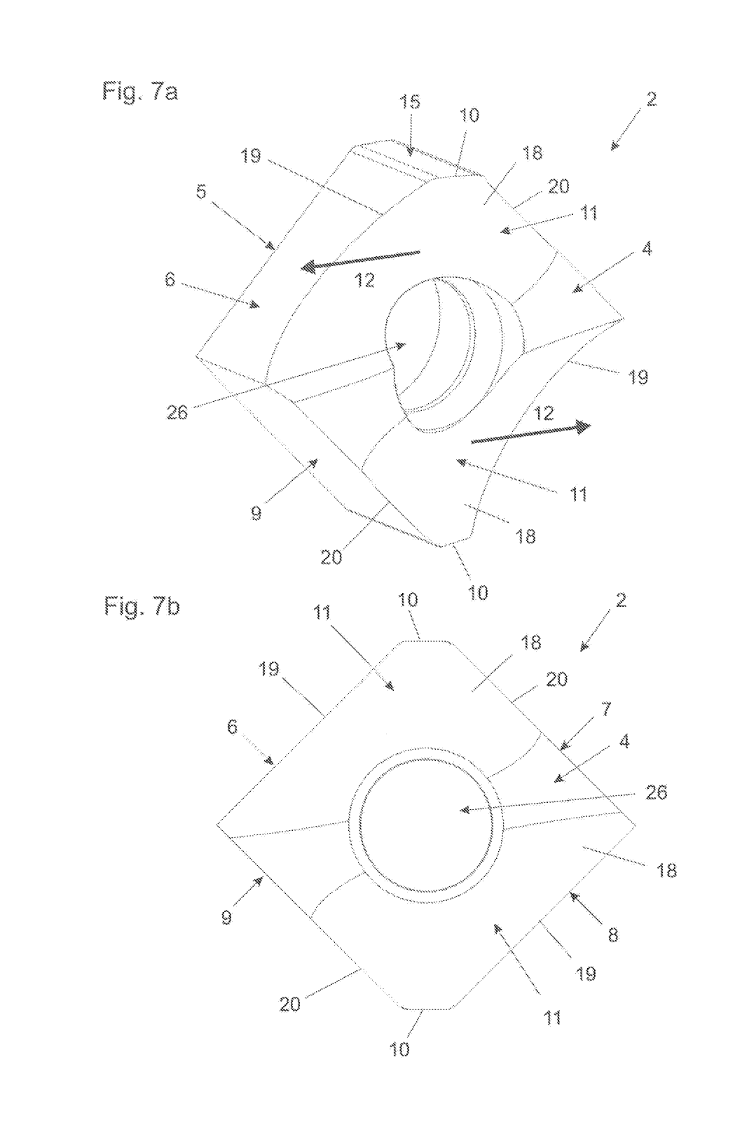

FIGS. 7a and 7b show a second preferred embodiment of a blade 2 according to the invention. In comparison with the first embodiment the blade 2 only has cutting edges 10 at a base surface 4 and chip spaces 11 arranged adjacent thereto. The oppositely disposed base surface 5 is flat. This means that the blade 2 is always supported on a blade holder 27 by way of the base surface 5. The flat parts of the base surface 4, as they are not used as a support surface, can be reduced to the benefit of the chip spaces 11. As a result the flow of material in the direction of the preferred material conveying direction 12 can be still further increased. The blade 2 can be used twice.

1. A blade for a comminuting machine for comminuting material, comprising two mutually parallel base surfaces and at least three lateral surfaces, wherein provided at at least one base surface in the region where two lateral surfaces meet is a cutting device and a chip space adjacent thereto, wherein the cutting device is in the form of a cutting edge, and the chip space is inclined with respect to the at least one base surface in such a way that material comminuted by the cutting device can preferably be conveyed in the direction of one of the lateral surfaces, wherein the chip space extends, preferably exclusively, between the two meeting lateral surfaces and has a first material outlet edge at one of the two meeting lateral surfaces and a second material outlet edge at the other of the two meeting lateral surfaces, wherein the first material outlet edge is recessed more greatly than the second material outlet edge—with respect to the at least one base surface—so that the greatest part of the material comminuted by the cutting device leaves the blade at the first material outlet edge by virtue of the inclination of the chip space.

2. The blade according to claim 1, wherein the cutting edge is of a width of 5 to 9 mm, preferably 7 mm, and/or is inclined with respect to the at least one base surface in the same direction as the chip space.

3. The blade according to claim 1, wherein the cutting edge is formed at a corner surface arranged between the two meeting lateral surfaces, preferably wherein the corner surface:
has a flattened portion to avoid contact with the material to be comminuted in the region which is opposite to the cutting edge and which adjoins the other base surface, and/or
includes substantially an angle of 45° relative to the two meeting lateral surfaces.

4. The blade according to claim 1, wherein the chip space:
is in the form of a passage widening in the preferred material conveying direction, and/or
is of a concave configuration, and/or
has a chip face which is in contact with the material comminuted by the cutting device and which is of a cylindrical, conical or spherical configuration, and/or
is at least region-wise of an arcuate configuration in cross-section.

5. The blade according to claim 1, wherein the two material outlet edges are at least region-wise of an arcuate configuration, particularly preferably wherein the first material outlet edge is of a greater curvature than the second material outlet edge.

6. The blade according to claim 1, wherein the chip space has a central axis which includes an acute angle relative to a central axis of the blade, that is oriented substantially normal to the two base surfaces, and/or relative to a central axis of the blade, that is oriented substantially parallel to the two base surfaces.

7. The blade according to claim 1, wherein the blade has more than one and preferably two or four cutting devices arranged at a base surface in the region where two lateral surfaces meet and chip spaces which are formed adjacent thereto so that the blade can be used a plurality of times, preferably twice or four times.

8. The blade according to claim 1, wherein provided at the at least one base surface in the second region where two lateral surfaces meet is a cutting device and a chip space formed adjacent thereto.

9. The blade according to claim 8, wherein the cutting device and the chip space of the second region are substantially identical to the cutting device and the chip space of the first region, preferably wherein the cutting device and the chip space of the second region are of a substantially point-symmetrical configuration relative to the cutting device and the chip space of the first region at the at least one base surface.

10. The blade according to claim 1, wherein the blade is substantially identical at the two base surfaces, preferably wherein the cutting edge and the chip space or the cutting edges and the chip spaces of the second base surface are arranged in a laterally reversed relationship and/or turned through 90° relative to the cutting edge and the chip space or the cutting edges and the chip spaces of the first base surface.

11. The blade according to claim 1, wherein:
the blade is of a substantially cuboidal configuration, and/or
the blade has a central through opening, preferably with a thread for connecting the blade to a blade holder, and/or
the at least one of the two bases surfaces is at least region-wise in the form of a support surface for supporting the blade at a blade holder.

12. A comminuting machine for comminuting material, in particular recyclable materials, waste wood and data carriers, including a machine frame, at least one comminuting rotor mounted rotatably to the machine frame, and a material feed space by way of which the material to be comminuted can be fed to the at least one comminuting rotor, wherein a plurality of blades according to claim 1 is arranged on the comminuting rotor.

13. The comminuting machine according to claim 12, wherein the blades are connected to the at least one comminuting rotor by way of blade holders.

14. The comminuting machine according to claim 12, wherein the comminuting machine includes a sieve device which region-wise surrounds the at least one comminuting rotor and by way of which the comminuted material can leave the comminuting machine, and wherein the cutting edges of the blades, that are active during the comminuting operation, substantially provide line contact with the sieve device.
